(19) United States
(12) Patent Application Publication
(10) Pub. No.: US 2013/0275904 A1
(43) Pub. Date: Oct. 17, 2013

(54) INTERACTIVE DATA VISUALIZATION AND MANIPULATION

(71) Applicant: SECONDPRISM INC., Santa Clara, CA (US)

(72) Inventors: Vivek Bhaskaran, Seattle, WA (US); Anup Surendran, Toronto (CA)

(73) Assignee: SECONDPRISM INC., Santa Clara, CA (US)

(21) Appl. No.: 13/779,763

(22) Filed: Feb. 28, 2013

Related U.S. Application Data
(60) Provisional application No. 61/622,532, filed on Apr. 11, 2012.

(51) Int. Cl. G06F 3/048

(52) U.S. Cl. CPC G06F 3/048
USPC 715/771

(57) ABSTRACT

A data visualization system is described herein that provides a user interface, such as for graphs of tabular data, that is more intuitive and faster to interact with than previous solutions. The system allows a user to directly interact with the interface through touch input by rotating, selecting, and viewing supplemental information. The user can perform various manipulations with simple input, such as touching particular choices to turn them on and off, dragging particular choices onto other choices to group the choices, and holding down on a particular group of choices to break apart the group. These types of interactions and the user interface provided by the system allow a user to quickly and efficiently switch between high-level visualization of data and a deeper dive into the underlying data, and to rearrange the data in ways that are meaningful to the user and that assist in consuming the data.

### CROSS-REFERENCE TO RELATED APPLICATIONS

The present application claims the benefit of U.S. Provisional Patent Application No. 61/622,532 (Attorney Docket No. SURVEY010) entitled “INTERACTIVE DATA VISUALIZATION AND MANIPULATION”, and filed on 2012 Apr. 11, which is hereby incorporated by reference.

### BACKGROUND

Businesses today are inundated with massive amounts of data related to internal metrics, product sales, progress reports, and so forth. All areas of business are impacted by various types of data and employees of many different job functions all the way up to the chief executive are tasked with digesting this data and making meaningful decisions. Over the years, various business intelligence and data visualization tools have been developed that help to turn large amounts of numeric data into spreadsheets, graphs, pictures, and other more easily digestible forms than raw numeric data. The data may come from a wide variety of systems including finance systems, human resource systems, sales systems, customer feedback systems, and so forth. Often each of these functional departments has its own types of data and tools for reporting and consuming that data.

Modern mobile devices have made computing tasks possible on the go that once required bulky desktop computer systems. Smartphones and tablet computers have made it easy to always have a powerful computing device available. However, these devices do not make it any easier to consume the vast amount of information that most users receive. Whether in business contexts like those described above, or organizing personal information, users of mobile devices suffer some of the same problems consuming large amounts of data that have existed for a long time.

Touch-based mobile devices provide a level of intimacy and ease of input between users and computing devices that did not exist in the days when a keyboard and mouse were the main tools for input. The ability to touch and manipulate information and user interfaces through gestures such as pinching, multi-finger touch, sliding, and so forth have enabled users to more readily manipulate information but have still not produced a solution to the vast amounts of information to be consumed. To use information effectively, users of computing devices need ways to effectively summarize large amounts of data into usable subsets.

### BRIEF DESCRIPTION OF THE DRAWINGS

FIG. 1 is a block diagram that illustrates components of the data visualization system, in one embodiment.

FIG. 2 is a flow diagram that illustrates processing of the data visualization system to display and drill down on data visualizations, in one embodiment.

FIG. 3 is a flow diagram that illustrates processing of the data visualization system to combine and share data, in one embodiment.

FIG. 4 is a display diagram that illustrates a graphical user interface provided by the data visualization system to illustrate information in a pie chart, in one embodiment.

FIG. 5 is a display diagram that illustrates a graphical user interface provided by the data visualization system to illustrate information in a pie chart after the user has manipulated the chart, in one embodiment.

FIG. 6 is a display diagram that illustrates a graphical user interface provided by the data visualization system to illustrate underlying data related to a chart, in one embodiment.

FIG. 7 is a display diagram that illustrates a graphical user interface provided by the data visualization system after a user has turned off one or more subsets of underlying data, in one embodiment.

FIG. 8 is a display diagram that illustrates a graphical user interface provided by the data visualization system after a user has grouped one or more subsets of underlying data, in one embodiment.

FIG. 9 is a display diagram that illustrates a graphical user interface provided by the data visualization system after a user has split apart a group of data, in one embodiment.

### DETAILED DESCRIPTION

A data visualization system is described herein that provides a user interface, such as for graphs of tabular data, which is more intuitive and faster to interact with than previous solutions. Using the example of a pie chart, the system allows a user to directly interact with the chart through touch input by rotating, selecting, and viewing supplemental information related to various pieces of the pie. For example, the system may display a pointer to a particular active pie piece, and then allow the user to rotate the chart using touch or other input to move new pieces into selection. By activating a control or performing a gesture (e.g., swiping or double tapping), the user can access the underlying data that generated the chart. For example, when a user requests viewing underlying data, the system may animate the chart to flip it over like a sheet of paper, then show a table of information related to the chart overlaid on a watermark (e.g., more transparent) image of the chart itself. The system then allows the user to work with the data in various ways that may affect the way the chart is displayed. For example, the user may turn on or off particular elements of the data. As one example, a survey may include five responses, such as very satisfied, satisfied, neutral, unsatisfied, and very unsatisfied. A chart visualizing this data may indicate what percentage of responses were for each of the possible response choices. The system allows the user to turn off particular elements, so that the user can visualize, for example, the breakdown of responses among those respondents that were not dissatisfied (e.g., neutral, satisfied, or very satisfied).

Upon manipulating the data in this way, the system may dynamically recalculate and update a displayed percentage of responses among the still active choices. In addition, the system may update a display of the chart shown in the background or elsewhere. Users may also manipulate data in other ways, such as by combining responses for particular choices into groups or breaking apart previously grouped responses. For example, the user may create a new group that includes very satisfied and satisfied responses, and another group that includes unsatisfied and very unsatisfied responses. Again, the system updates the percentages or other calculations and any visual display based on the user's interaction with the underlying data. The user can perform all of these manipulations with simple input, such as touching particular choices to turn them on and off, dragging particular choices onto other choices to group the choices, and holding down on a particular group of choices to break apart the group. These types of interactions and the user interface provided by the data visualization system allow a user to very quickly and efficiently switch between high-level visualization of data and a deeper dive into the underlying data, as well as to rearrange the data in ways that are meaningful to the user and that assist in consuming the data. Thus, the data visualization system provides more useful access to complex information through an improved user interface that can leverage mobile devices and touch-based input to increase user efficiency.

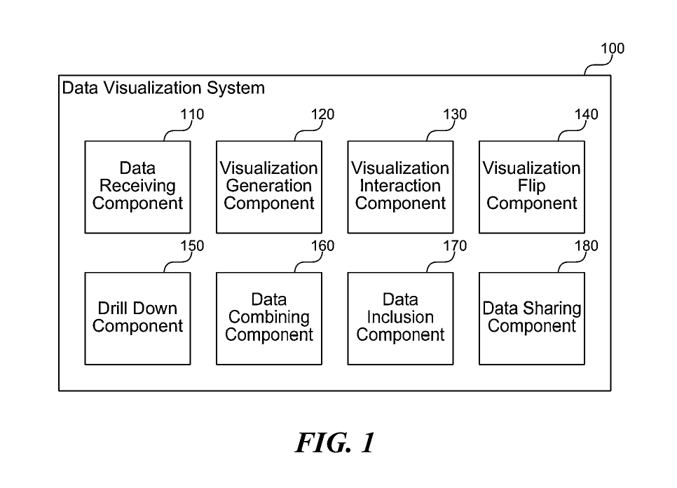

FIG. 1 is a block diagram that illustrates components of the data visualization system, in one embodiment. The system 100 includes a data receiving component 110, a visualization generation component 120, a visualization interaction component 130, a visualization flip component 140, a drill down component 150, a data combining component 160, a data inclusion component 170, and a data sharing component 180. Each of these components is described in further detail herein.

The data receiving component 110 receives data from one or more sources and systems for visualization with the data visualization system 100. Data may come from a variety of sources, many of which will already be available when the system 100 is deployed in a particular organization. Conceptually, the data may come from finances systems, human resource systems, sales systems, customer relationship management (CRM) systems, or other systems of an organization, as well as personal systems used in non-corporate environment, such as a family's financial planning software, banking data, tax data, and so forth. Physically, the data may be stored in a variety of sources, such as databases, cloud-based storage services, files, file systems, hard drives, storage area networks (SANs), and so forth. Each of these types of data sources provides an application-programming interface (API) or other facility for communicating with the source and extracting data, and one purpose of the data receiving component 110 is to invoke these facilities to communicate with sources selected by the user to pull data the user is interested in into the system 100 for visualization. For example, the data receiving component 110 may submit a query to a relational database that produces tabular data as output that can then be visualized by the system through one or more types of graphs or other visualizations.

The visualization generation component 120 generates an initial visualization of the received data and updates the visualization based upon touch-based interaction received from the user. Touch-based interaction may include many types of modern forms of input, such as touch with the user's finger, use of a stylus or digitizer, or other types of highly interactive input (e.g., voice input). The initial visualization may include a chart automatically determined by the system 100 to be suitable for the particular data received, such as a pie chart, line chart, bar graph, or other visualization. The component 120 may also be configured to produce a particular type of visualization for particular types of data. For example, multiple choice survey responses may initially be presented as a pie chart, while time series data may initially be presented as a line graph. The component 120 may also offer the user a set of available visualizations so that the user can choose how the system 100 displays the received data. The visualization generation component 120 generates a high-resolution visualization using modern mobile computing devices that is rich (e.g., using colors, gradients, and other features where appropriate) and highly interactive (assigning touch targets to various regions of the visualization that users can interact with by touching). Through this, the system 100 can display big amounts of data in a visualization that conveys visual simplicity and makes consumption of the data more efficient.

The visualization generation component 120 may also receive information about a device type being used to display the visualization and may tailor the visualization to suit the received device type. For example, some visualizations may work better on a tablet than a smartphone, and the component 120 may adjust the visualization based on a screen form factor. The component 120 may display more information on a larger screen, while adopting a scrolling, panning, or other model to place more information off-screen for a smaller screen. An operator of the system can configure how the system reacts to various devices based on group and usability testing, or other goals of a particular organization or deployment target for the system 100.

The visualization interaction component 130 receives one more user interactions from the user, wherein the interactions request more information or an adjustment to the received data displayed by the generated visualization. The interactions may include swipes left or right for navigation, turning on or off various options or data points, combining and splitting data groups, rapidly jumping from one data point to another, automatically zooming into particular data elements, sharing data and enabling collaboration features, manipulating a dynamic area/percent display for linear data, drilling down further into data underlying the visualization, and so forth. The component 130 interacts with an operating system or other layer of a mobile computing device to receive touch-based input and to identify a target area of the visualization that is a subject of the received input. For example, the component 130 may detect that a user viewing a pie chart touched a particular piece of the pie, which may imply drilling down into the data underlying that pie piece. As another example, the component 130 may detect that the user has touched an on-screen control that requests flipping the visualization over to display underlying data related to the visualization.

The visualization flip component 140 provides a flip mode whereby the user can interact with the visualization through touch-based input to flip the generated visualization over and view the received data underlying the visualization. For example, upon flipping over a pie chart, the component 140 may display a table of data related to each element in the pie chart. For a survey of five responses, the table may include how many respondents chose each response option, as well as additional data not currently shown in the visualization, such as a breakdown of survey respondents by age, gender, or other characteristics. Upon viewing the detailed data, the user may choose to select options to include particular elements of data in the visualization or to remove particular elements from the visualization. Continuing the previous survey example, the user may choose to view the outcome of the survey with only responses from female respondents in a pie chart. Thus, the user may manipulate the data in this way and exit the flip mode (e.g., flipping back over to the chart) to see how the data now looks visually with the adjustments that the user made.

The drill down component 150 receives interaction requests from the user to drill down into data associated with a selected element of a displayed visualization. For example, the user may touch a pie piece of a pie chart, a point on a line graph, or other visualization element to request more information about the underlying data. The system 100 may display additional information in a pop-up dialog box or other display, such as a balloon with text connected to the data element. The data displayed may include particular rows or columns of underlying tabular data, or other information related to the selected visualization element. In addition to the core data of the visualization, the user may also drill down and interact with other elements, such as a scale of a graph, labels of the visualization, configuration options, and so forth. In such cases, drilling down by selecting the elements displays to the user any options for the selected element that the user can manipulate, and receives from the user any associated manipulations. When the user is finished, the user can close the drill down information and any changes made are reflected through an updated display of the visualization.

The data combining component 160 receives interaction requests from the user to combine data points within the received data to create a new data group and requests to split previously grouped data points. A user can group data easily using drag and drop or other paradigms. For example, by dragging one data point on top of another, the user can create a new data group that includes both data points. By tapping and holding the created data group, the user can split the created group back into its component parts. This can be useful for many types of data. For example, a survey question with multiple choices along a scale may have some responses that represent positive outcomes and others that represent negative outcomes. By combining responses, the user can view the differences between positive and negative outcomes, and by splitting the responses, the user can view more fine-grained points of data along the scale. By combining data grouping with the data inclusion functionality described next, the user could also view just the component parts of the positive responses or just the component parts of the negative responses.

The data inclusion component 170 receives interaction requests from the user to show and hide particular data points within the received data. For example, in a survey question with five possible responses, the user may tap a particular response to exclude that response from a displayed pie chart or other visualization, and may tap the response again to include it. The user interface may gray out, uncheck, or make some other indication of which elements are included and which are not. This allows the user to dynamically update the visualization to visually observe various facets of the underlying data. The user may use the data inclusion component 170 in combination with the visualization flip component 140 to flip the display to see a deep level of underlying data, and then make selections related to which data will and will not be included in an updated visualization.

The data sharing component 180 exposes data and visualizations used with the system to other external systems via an application-programming interface (API). For example, the system may provide a representational state transfer (REST)/JavaScript object notation (JSON) model through which external web sites and services can make a web request via hypertext transfer protocol (HTTP) or other protocols to receive data and visualization information from the system 100. This allows external systems to combine their own data with that of the system 100, to provide additional services, and so forth. In some embodiments, the system 100 allows customization of branding and other user interface components so that external systems can place their own experience around the data. Users can also share data and visualizations produced by the system via social networks or other modes of communication (e.g., email). Users may also spotlight particularly interesting data points so that other users of the system, when viewing the same data, will see particular emphasis on the spotlighted data. This showcases any discoveries one user has made and allows these discoveries to be conveyed to other users and to be provided to the user each time they each view the data.

The computing device on which the data visualization system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

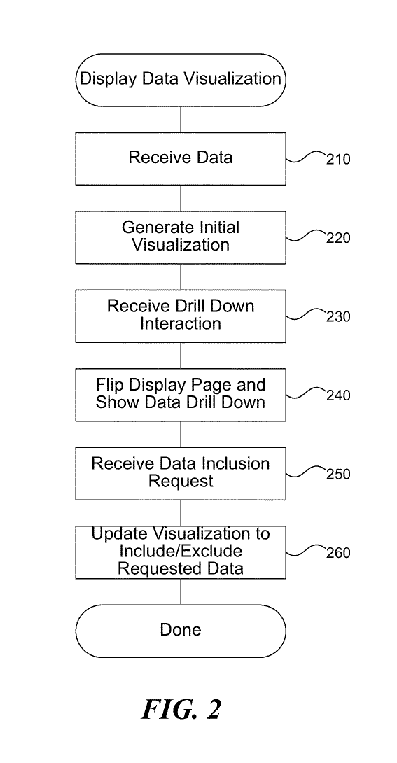

FIG. 2 is a flow diagram that illustrates processing of the data visualization system to display and drill down on data visualizations, in one embodiment. Beginning in block 210, the system receives data to be displayed visually through one or more visualizations. The data may be received from a database, cloud-based storage service, or other resource for storing data. The data format may include tabular or other forms of data that can be graphed, charted, or otherwise displayed visually to convey information to a user. The data may be received via one or more application programming interfaces (APIs) for receiving data from the storage resources. In some cases, the system may receive data from multiple sources and combine (or join) the data in meaningful ways to display the data visually to the user.

Continuing in block 220, the system generates an initial visualization that graphically represents at least some of the received data. The initial visualization may be automatically determined based on characteristics of the data (e.g., whether it contains a time series, a limited number of values, and so forth). The initial visualization may also be determined based on a user request or configuration information previously stored that indicates what type of initial visualization the user prefers. For example, for data having a small range of values (e.g., a survey or test question with five possible responses), the initial visualization may be a pie chart, where each pie piece represents one value in the range. The user can then interact with the visualization by selecting particular pieces, rotating the visualization, zooming in, and so on.

Continuing in block 230, the system receives a touch-based request from a user that indicates that the user wants to drill down on one or more data elements underlying the generated visualization. The user may select a particular element in a graph (e.g., a pie piece of a pie chart or a data point on a line graph), touch a separate control for drilling down on data, rotate a graph or chart so that a particular element is selected by a cursor or pointer displayed at the edge of the graph or chart, and so forth. The data visualization system encourages users to interact directly with displayed visualizations, such that many elements of the visualization respond to simple touches as well as more complex gestures (e.g., pinching, panning, zooming, rotating, and so forth).

Continuing in block 240, the system displays an animation that flips the visualization over and displays drill down data on the backside of the visualization. The system may display the visualization as a watermark (e.g., semi-transparent display) beneath tables or other displays of raw data. The user can then interact with the displayed data, such as by touching particular data elements to turn selected elements on and off in the displayed visualization, dragging elements over other elements to combine the elements and create groups, touching and holding to split previously created groups into individual elements, and so on. In addition to the flip style of drilling down, the system may also display pop up boxes, update a detail area displayed alongside the visualization, or preform other visual modifications that convey a deeper level of data to the user associated with data elements selected by the user from the displayed visualization.

Continuing in block 250, the system receives a touch-based request from the user that indicates that the user wants to include or exclude data in the displayed visualization. For example, the system may display a list of data points that can be included in the visualization, and the user may touch data points to toggle them on or off depending on each data point's current state. If the user taps a data point that is currently included in the visualization, then that data point is turned off (e.g., visually grayed or unchecked), and the displayed visualization is updated to display the remaining data points. Similarly, if the user taps a data point that is currently excluded from the visualization, then the data point is turned on and the displayed visualization is updated to display the new set of data points.

Continuing in block 260, the system updates the displayed visualization to include or exclude the data as requested by the user. The displayed data is thus directly accessible to the user to manipulate through the intimate input methods of touch-based input. The user may use his or her finger(s) to touch data on a smartphone or tablet, or use other input methods (e.g., stylus or pen) that allow a more direct connection between what the user sees and how the user can interact with what is displayed. This gives the user a very powerful mode of interaction that eliminates unnecessary learning of correlations between more indirect methods of input and their effects on displayed information. After block 260, these steps conclude.

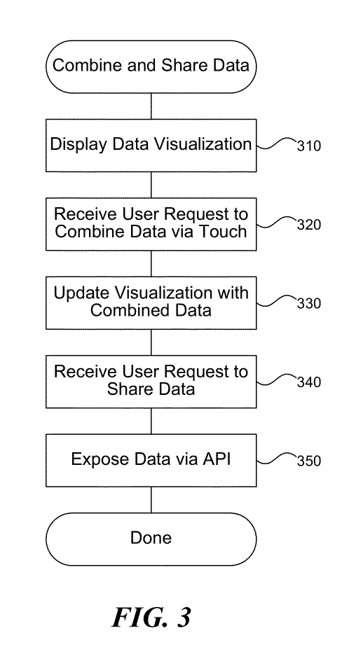

FIG. 3 is a flow diagram that illustrates processing of the data visualization system to combine and share data, in one embodiment. Beginning in block 310, the system displays a graphical visualization of data requested by a user, wherein the data includes multiple data points expressed within the displayed visualization. The visualization may be one like that displayed based on the steps of FIG. 2, or through a similar method. The displayed visualization may include a graph, chart, or other graphical representation of the data. The visualization is displayed on a mobile computing device that has input hardware capable of receiving touch-based or other direct input from the user, where the user can see the visualization and then provide input to interact with it.

Continuing in block 320, the system receives a request via user touch-based input to combine two or more of the data points into a group or to split two previously combined data points back into individual data points. Data points may be related or fall naturally into groups. For example, responses to a survey that come from each time zone of the United States, may also be grouped where the western half of the U.S. is in one group, and the eastern half is in another. Similarly, responses that indicate a spectrum (e.g., very satisfied, satisfied, neutral, unsatisfied, very unsatisfied) may be grouped into less granular groups (e.g., both very satisfied and satisfied may be grouped together as happy customers) or any other grouping that a particular user finds useful.

Continuing in block 330, the system updates the displayed visualization to display the data points in the groups created or ungrouped by the user's request. For example, if the visualization is a pie chart that previously had five pie pieces, and the user's action requested that two of the pieces be combined, then the result is a pie chart with four pie pieces, where the two data points combined by the user are now represented by one pie piece. The user can group and ungroup data, display that data visually, and then glean interesting conclusions from the visualized data. Upon finding a particularly interesting correlation or display of the data, the user may then wish to share that data with others (e.g., friends or a manager) so that they, too, can benefit from the message that the data conveys.

Continuing in block 340, the system receives a user request to share the data and displayed visualization with another user. The system may provide a variety of options for sharing, such as posting a link on a social network like Facebook or Twitter, exposing functionality of the system to external websites via REST/JSON, providing other web services APIs, providing other ways of linking to specific data, and so forth. When a user finds an interesting data correlation illustrated by a visualization, the user may add comments or highlight the interesting part of the visualization through visual tools provided by the system (e.g., a highlight tool or comment feature), so that other users viewing the same data are presented with the user's observations. The system may also provide a uniform resource locator (URL) scheme that allows the user to provide a link to the visualization to other users.

Continuing in block 350, the system exposes the shared data requested by the user to one or more other users. Upon receiving a request by the other user to display the data, the system displays the view shared by the first user, along with any comments, spotlights, or other emphasis left by the first user. The second user may then interact with the visualization and manipulate the data to identify new correlations, and may share those in response. After block 350, these steps conclude.

The following paragraphs provide descriptions and visual examples of various aspects of the data visualization system including: manipulating a chart of data by touch, using a pointer to activate a particular subset of the data, navigating to data underlying the chart, turning on and off subsets of data, combining data into groups, and breaking groups of data into individual group members.

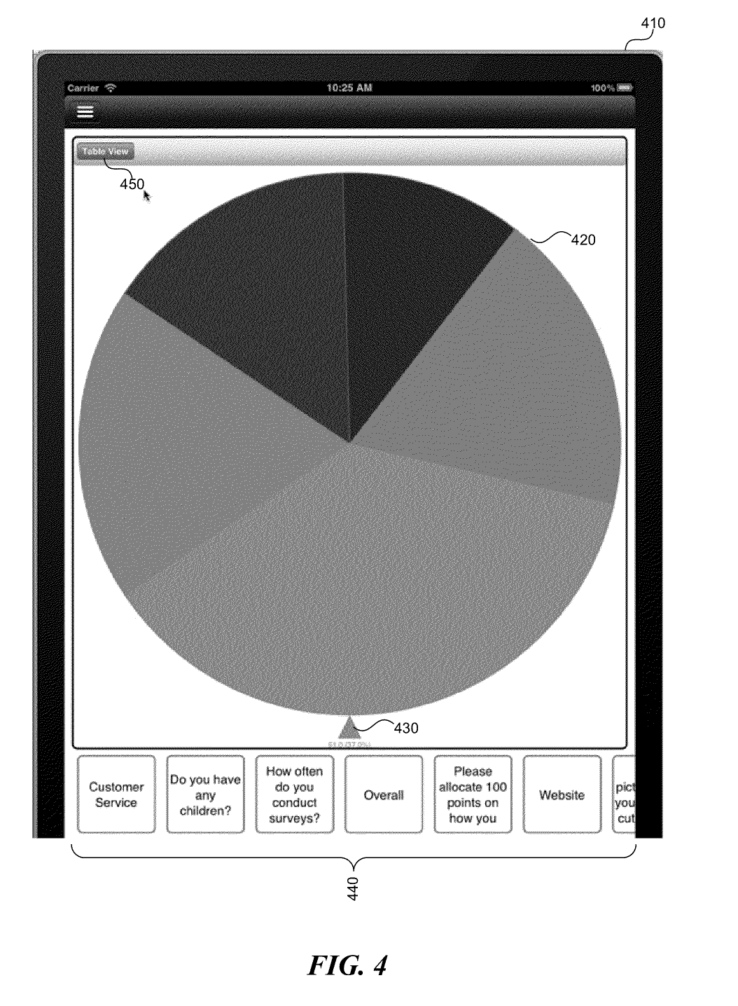

FIG. 4 is a display diagram that illustrates a graphical user interface provided by the data visualization system to illustrate information in a pie chart, in one embodiment. The interface may be displayed on a tablet, such as an APPLE™ IPAD™, a smartphone, or other computing device. Although well suited for mobile applications, the system can also be used in traditional personal computers, game consoles, set-top boxes, and other computing devices. The interface 410 includes a pie chart 420 with five pie pieces corresponding to various subsets of the data set being displayed. The information 440 along the bottom may include various sets of data that, upon selection, can be displayed in pie chart or other form. The bottom of the pie chart includes a triangular pointer or cursor 430 that points to one of the pie pieces and displays related information, such as a quantity and percentage of the underlying data that is generating the indicated pie piece. For example, the data may include a number of respondents that provided a particular answer to a question, and the percentage of the total responses represented by that answer. A “table view” button 450 allows viewing underlying tabular data that relates to the displayed chart (e.g., by flipping the page over as described herein). Although a pie chart is used in the illustrations herein, the system can be applied to other types of data visualizations, such as bar graphs, line charts, Venn diagrams, and the like.

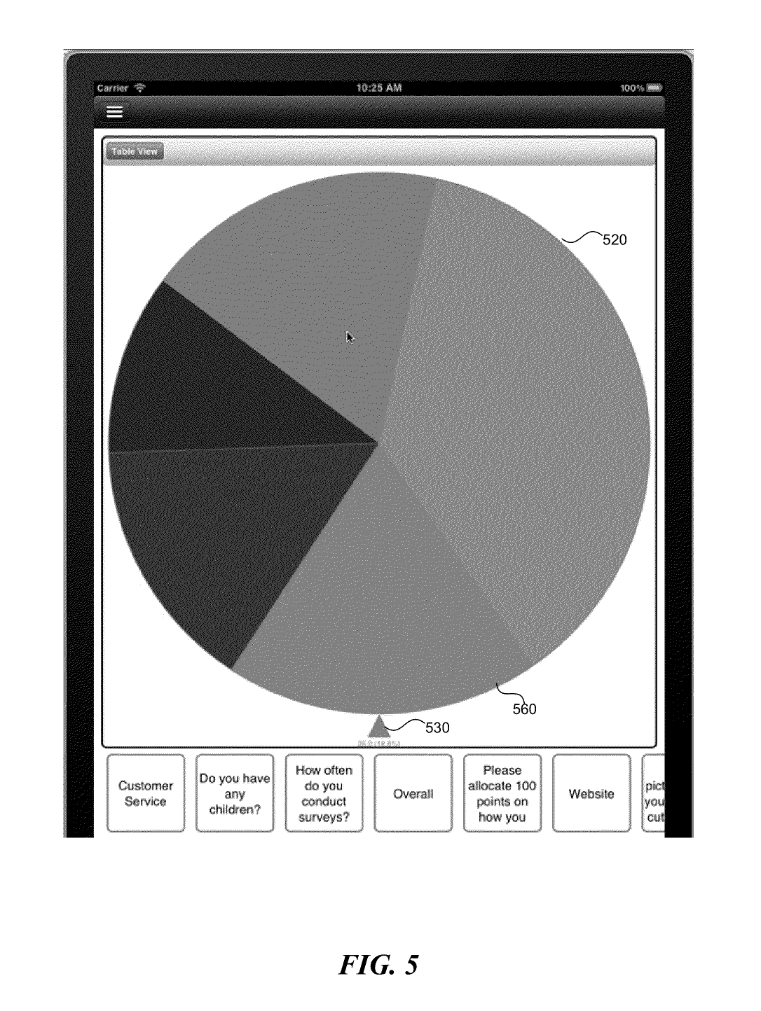

FIG. 5 is a display diagram that illustrates a graphical user interface provided by the data visualization system to illustrate information in a pie chart after the user has manipulated the chart, in one embodiment. The data of FIG. 5 is the same as that of FIG. 4, except the user has rotated the chart 520 such that a new piece 560 of the pie is selected by the triangular cursor 530. The information associated with the cursor 530 has been updated to reflect information related to the selected subset of data. The user can manipulate the chart 520 using a touch interface by touching the chart 520 and pulling one edge, so that the pie chart 520 rotates around a central axis. The user may also use traditional forms of input, like a mouse, or advanced input like voice recognition to manipulate the chart 520. For other types of charts or graphs the user might drag a line from left to right along an x-axis (e.g., for a line chart) or perform other manipulations.

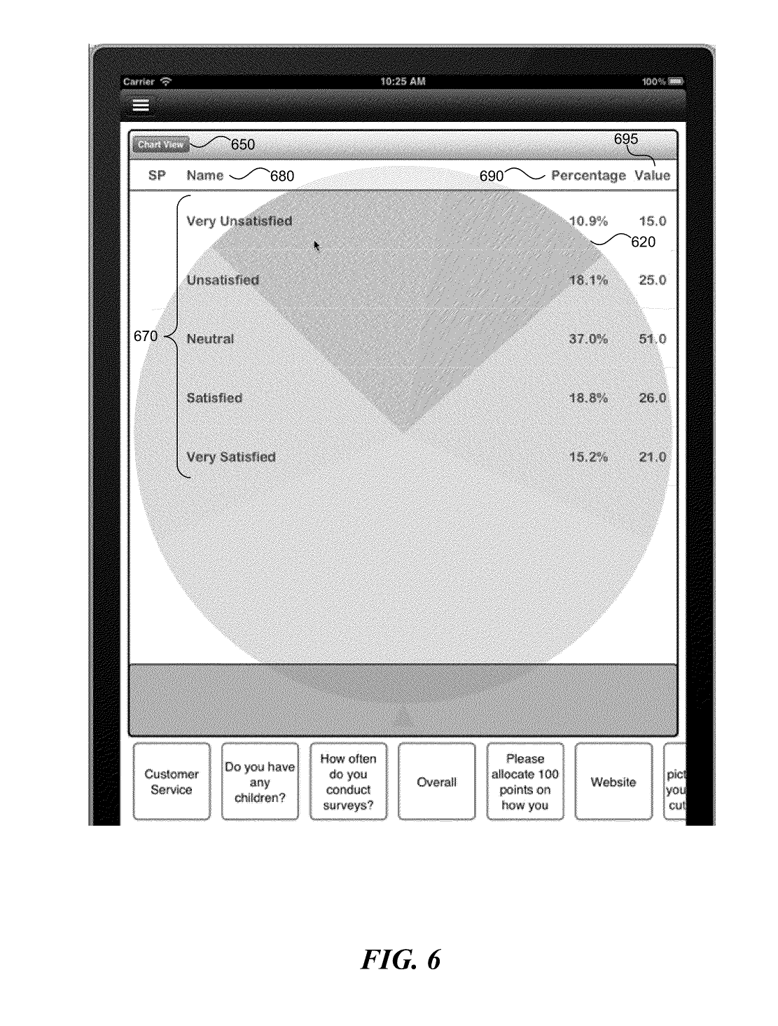

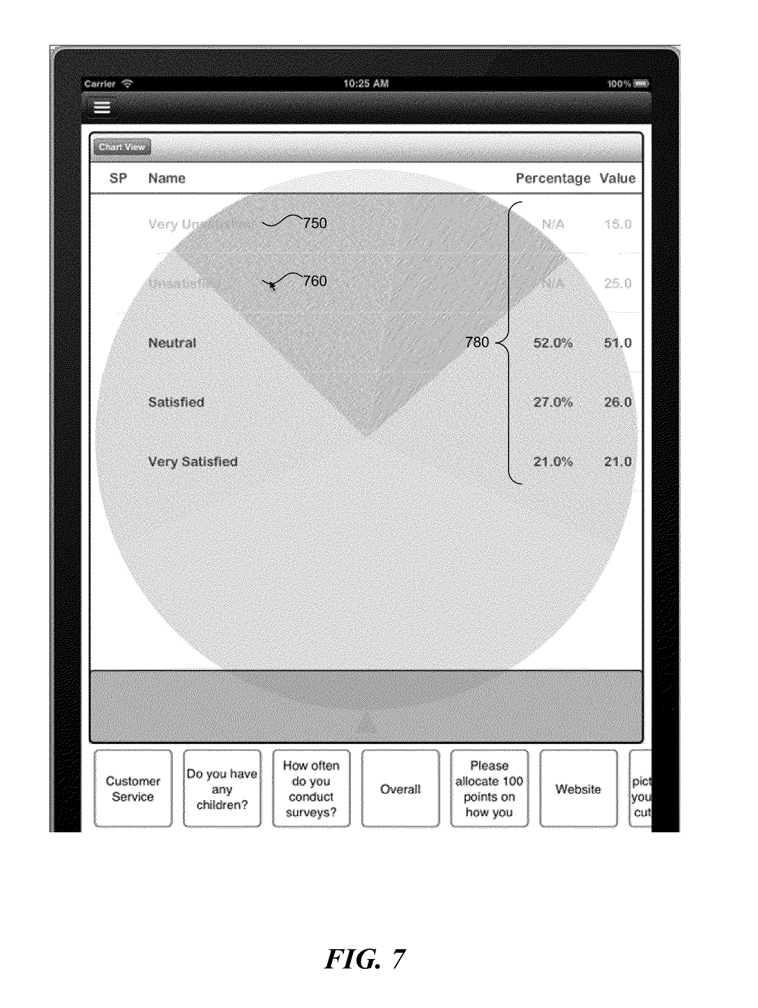

FIG. 6 is a display diagram that illustrates a graphical user interface provided by the data visualization system to illustrate underlying data related to a chart, in one embodiment. The user may arrive at the display of FIG. 6 by selecting the “table view” button in FIGS. 4 and 5, or by performing a gesture or other input, such as swiping or double tapping. The table view 670 illustrates a table of underlying data that includes a name 680 for each data element, a percentage 690 associated with that element, and a value 695 associated with that element. Although a simple data set is shown for ease of illustration, the techniques of the data visualization system make it possible for users to interact with potentially large amounts of data in a straightforward manner and without complex input. The user can perform various manipulations of the underlying data that then influence how the chart is graphically displayed. Several example manipulations are described with reference to FIGS. 7, 8, and 9. These figures continue the example given above, in which the charted data indicates responses to a survey question that has five possible choices. Also shown in FIG. 6, the table view button has become a chart view button 650, and allows the user to return to the visualization, updated to reflect any changes or selections the user made to the data. In addition, the visualization may be still displayed in the table view via a semi-transparent watermark 620, like that shown, or through other visual methods (e.g., a small inset).

FIG. 7 is a display diagram that illustrates a graphical user interface provided by the data visualization system after a user has turned off one or more subsets of underlying data, in one embodiment. In the example displayed, the user has turned off the very unsatisfied 750 and unsatisfied 760 responses. The user may do this by tapping these responses on a touch-based interface, clicking on them with a mouse, speaking the names of the responses, or by other forms of input. The display shows the responses as greyed out to indicate that they are inactive or not currently reflected in the chart. In addition, the system has updated the percentages 780 displayed at the right to reflect the relative breakdown of the remaining, active responses. A user can very quickly tap to select various data subsets for inclusion or exclusion from the charted data.

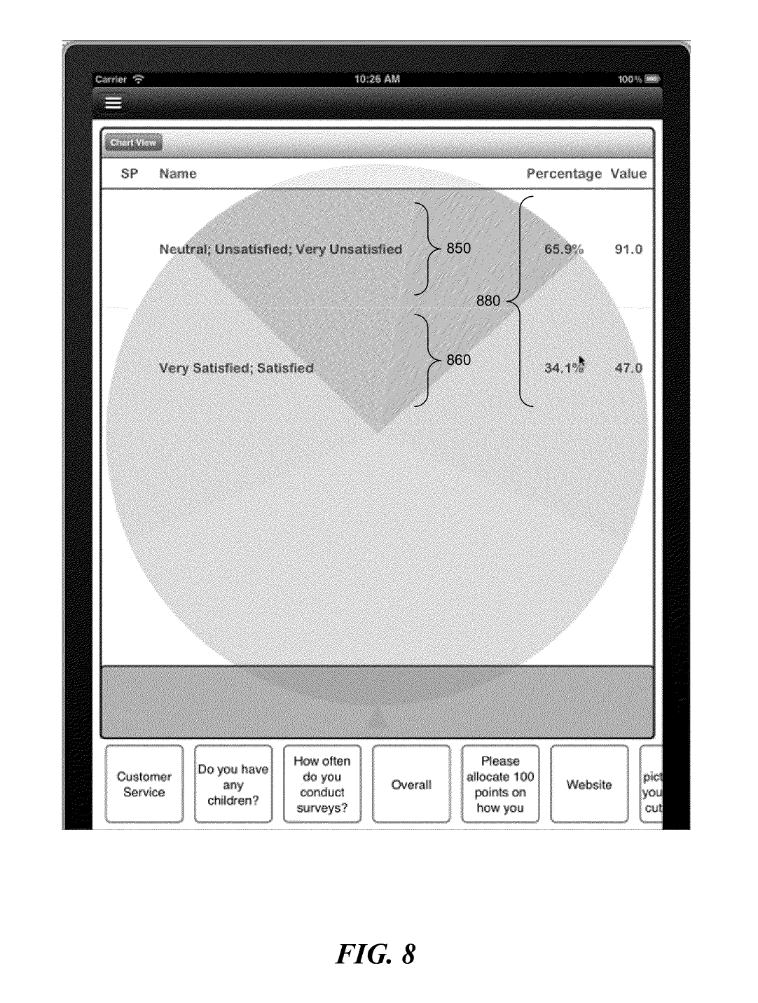

FIG. 8 is a display diagram that illustrates a graphical user interface provided by the data visualization system after a user has grouped one or more subsets of underlying data, in one embodiment. In the example displayed, the user has grouped the neutral, unsatisfied, and very unsatisfied responses together in a first group 850 and the satisfied and unsatisfied responses together in a second group 860. The user may do this by dragging one response onto another, such as through touch, mouse, or voice input. In some embodiments, the system may display grab handles or other user interface hints that are known in the art to inform users of the possible actions with the data. By grouping data subsets, the system allows the user to quickly combine data in ways that are meaningful for the user to digest and make decisions based on the data. In addition, the system has updated the percentages 880 displayed at the right to reflect the relative breakdown of the new groups. The system may also update the chart displayed in the background based on the new percentages (not shown).

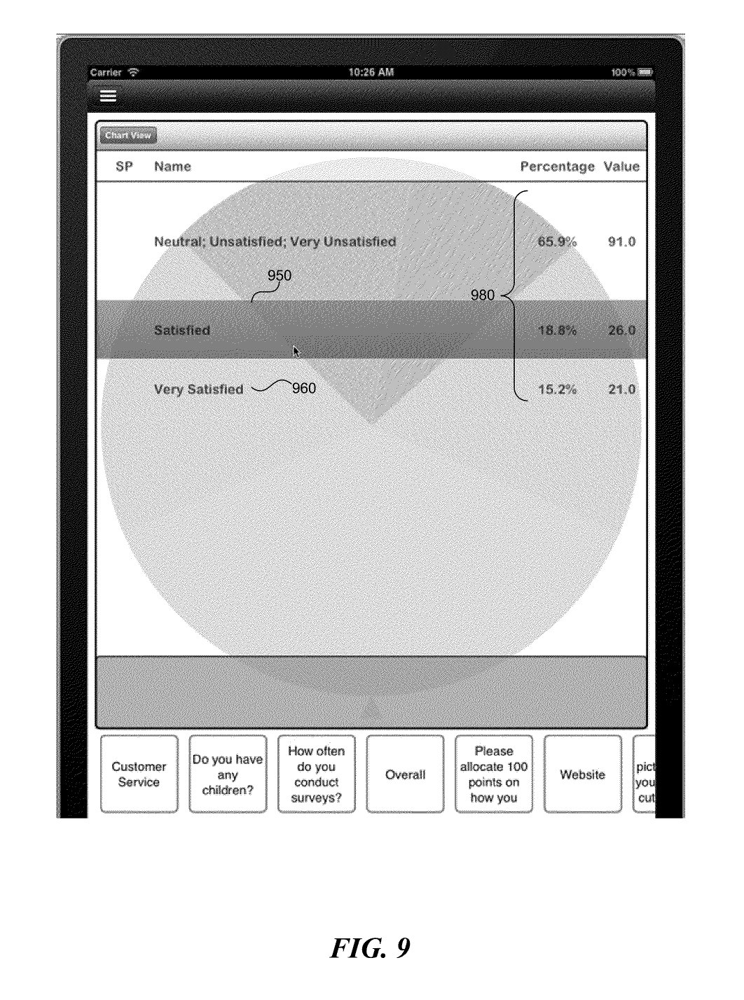

FIG. 9 is a display diagram that illustrates a graphical user interface provided by the data visualization system after a user has split apart a group of data, in one embodiment. Continuing from FIG. 8, the user has broken apart the group previously including satisfied 950 and very satisfied 960 responses. The user may do this by tapping and holding the group or performing another gesture or action that signals a user request to un-group data. As before, the system updates the percentages 980 at the right based on the new subsets of data, and may update the displayed chart form of the data (not shown).

In some embodiments, the data visualization system allows users to export data from the system for other purposes. After the user has manipulated the data in a particular manner to produce a chart or other visualization, the user may want to use the result in another application or for another purpose. For example, the user may use the system to build a chart and table of data that the user then wants to use in a presentation or spreadsheet. The system provides an export interface through which users can capture information from the system and export that information to other software. The system may leverage screenshot, clipboard, or other functionality provided by an operating system to communicate results of the data visualization system to other applications.

In some embodiments, the data visualization system allows users to manipulate scale and other visualization parameters. For example, a user may grab and pinch to expand or contract the scale of an x-axis or y-axis of a line or bar chart. As another example, the user may be able to drag along an axis to bring a different set of data values into focus. In this way, the system can display and chart a particular window of the data at any particular time as requested by the user.

From the foregoing, it will be appreciated that specific embodiments of the data visualization system have been described herein for purposes of illustration, but that various modifications may be made without deviating from the spirit and scope of the invention. Accordingly, the invention is not limited except as by the appended claims.

I/We claim:

1. A computer-implemented method to display and drill down on data visualizations via touch-based input, the method comprising:
receiving data to be displayed visually through one or more visualizations on a mobile computing device;
generating an initial visualization that graphically represents at least some of the received data;
receiving a touch-based request from a user that indicates that the user wants to drill down on one or more data elements underlying the generated visualization;
displaying an animation that flips the visualization over and displays drill down data on the virtual backside of the visualization;
receiving a touch-based request from the user that indicates that the user wants to include or exclude data in the displayed visualization; and
updating the displayed visualization to include or exclude the data requested by the user,
wherein the preceding steps are performed by at least one processor.

2. The method of claim 1 wherein receiving data comprises accessing data from a data storage device via an application programming interface (API) provided by the data storage device.

3. The method of claim 1 wherein receiving data comprises receiving data in a tabular format and selecting data points within the data to display via the visualization.

4. The method of claim 1 wherein generating the initial visualization comprises automatically determining a type of visualization based on characteristics of the data.

5. The method of claim 1 wherein generating the initial visualization comprises determining a type of the visualization based on a user request or configuration information previously stored that indicates what type of initial visualization the user prefers.

6. The method of claim 1 wherein generating the initial visualization comprises making the visualization such that the user can interact with the visualization by selecting particular elements of the visualization using touch-based input.

7. The method of claim 1 wherein receiving the drill down request comprises detecting that the user selected a particular element in a graph visualization.

8. The method of claim 1 wherein receiving the drill down request comprises detecting that the user performed a gesture associated with receiving additional information about underlying data of the visualization.

9. The method of claim 1 wherein receiving the drill down request comprises detecting that the user moved the visualization so that a particular element of the visualization is selected by a fixed cursor that points at the visualization.

10. The method of claim 1 wherein displaying drill down data comprises continuing to display the visualization as a semi-transparent watermark beneath a table or other display of textual data.

11. The method of claim 1 wherein displaying drill down data comprises displaying interactive data that the user can interact with to modify the data and update the visualization.

12. The method of claim 1 wherein receiving the request to include or exclude data comprises displaying a list of data points that can be included in the visualization, and upon detecting that the user has touched a data point, toggling that data point on or off depending on the data point's previous state.

13. A computer system for interactive data visualization and manipulation using mobile, touch-based computing hardware, the system comprising:
a processor and memory configured to execute software instructions embodied within the following components;
a data receiving component that receives data from one or more sources and systems for visualization with the computer system;
a visualization generation component that generates an initial visualization of the received data and updates the visualization based upon touch-based interaction received from the user;
a visualization interaction component that receives one more user interactions from the user, wherein the interactions request more information or an adjustment to the received data displayed by the generated visualization;
a visualization flip component that provides a flip mode whereby the user can interact with the visualization through touch-based input to flip the generated visualization over and view the received data underlying the visualization;
a drill down component that receives interaction requests from the user to drill down into data associated with a selected element of a displayed visualization;
a data combining component that receives interaction requests from the user to combine data points within the received data to create a new data group and requests to split previously grouped data points;
a data inclusion component that receives interaction requests from the user to show and hide particular data points within the received data; and
a data sharing component that exposes data and visualizations used with the system to other external systems via an application programming interface (API).

14. The system of claim 13 wherein the visualization generation component generates a visualization that is high resolution, rich in color, and highly interactive via touch-based input.

15. The system of claim 13 wherein the visualization generation component generates a visualization that displays large amounts of data in a visualization that conveys visual simplicity and makes consumption of the data more efficient for the user.

16. The system of claim 13 wherein the visualization generation component receives information about a device type being used to display the visualization and tailors the visualization to suit the received device type.

17. The system of claim 13 wherein the visualization interaction component receives interactions that include at least one of swipes left or right for navigation, turning on or off various options or data points, combining and splitting data groups, rapidly jumping from one data point to another, automatically zooming into particular data elements, sharing data and enabling collaboration features, manipulating a dynamic area/percent display for linear data, and drilling down further into data underlying the visualization.

18. The system of claim 13 wherein the visualization interaction component interacts with an operating system of a mobile computing device to receive touch-based input and to identify a target area of the visualization that is a subject of the received interaction.

19. The system of claim 13 wherein the data sharing component exposes a representational state transfer (REST)/JavaScript Object Notation (JSON)-based API to external systems.

20. A computer-readable storage medium comprising instructions for controlling a computer system to combine and share interactive visual data, wherein the instructions, upon execution, cause a processor to perform actions comprising:
displaying a graphical visualization of data requested by a user, wherein the data includes multiple data points expressed within the displayed visualization;
receiving a request via user touch-based input to combine two or more of the data points into a group or to split two previously combined data points back into individual data points;
updating the displayed visualization to display the data points in the groups created or ungrouped by the user's request;
receiving a user request to share the data and displayed visualization with another user; and
exposing the shared data requested by the user to one or more other users.
